(19) United States
(12) Patent Application Publication
(10) Pub. No.: US 2020/0365941 A1
(43) Pub. Date: Nov. 19, 2020

(54) ELECTROLYTE SOLUTION FOR LITHIUM-IRON-PHOSPHATE-BASED LITHIUM SECONDARY BATTERY AND LITHIUM SECONDARY BATTERY COMPRISING SAME

(71) Applicants: HYUNDAI MOTOR COMPANY, Seoul (KR); KIA Motors Corporation, Seoul (KR)

(72) Inventor: Jong Chan SONG, Suwon-si (KR)

(73) Assignees: HYUNDAI MOTOR COMPANY, Seoul (KR); KIA Motors Corporation, Seoul (KR)

(21) Appl. No.: 16/703,208

(22) Filed: Dec. 4, 2019

(30) Foreign Application Priority Data
May 15, 2019 (KR) 10-2019-0056795

(51) Int. Cl. H01M 10/0567; H01M 10/0569; H01M 10/0525; H01M 2/16; H01M 4/58; H01M 4/583

(52) U.S. Cl. CPC H01M 10/0567; H01M 10/0569; H01M 4/583; H01M 2/1673; H01M 4/5825; H01M 10/0525

(57) ABSTRACT

The present disclosure relates to an electrolyte solution for a lithium-iron-phosphate-based lithium secondary battery and a lithium secondary battery including the same, in which the electrolyte solution includes a lithium salt and a salt additive in place of the existing rare-earth materials, thereby providing the price competitiveness of a battery and moreover increasing the energy density and capacity of a battery without increasing the thickness thereof.

### CROSS REFERENCE TO RELATED APPLICATION

This application claims priority to and the benefit of Korean Patent Application No. 10-2019-0056795, filed on May 15, 2019, the entire contents of which are incorporated herein by reference.

### FIELD

The present disclosure relates to an electrolyte solution for a lithium-iron-phosphate-based lithium secondary battery, in which the existing rare-earth materials are replaced thereby providing a battery that is price competitive as well as capable of improving energy density and battery capacity without an increase in the thickness thereof, and to a lithium secondary battery including the same.

### BACKGROUND

The statements in this section merely provide background information related to the present disclosure and may not constitute prior art.

With the advancement of electronic products and increase in consumers' preference for electric vehicles, market demand for the development of lightweight, high-capacity, and inexpensive secondary batteries is increasing. Among the different factors, cost is the most important when it comes to market entry. As for lithium ion batteries, which are mainly used these days, rare-earth materials such as Co/Ni are used, thereby imposing limitations on reducing the cost of manufacturing the batteries.

To address these limitations, alternative cathodes such as LiFePO₄, S₈, and O₂, which contain no rare-earth element, are being developed. Currently, S₈ and O₂ alternative cathodes remain in the basic research stage, and require more time for development. On the other hand, the LiFePO₄ cathode is currently being mass-produced, but it is difficult to manufacture a battery having high energy density due to its relatively low capacity compared to a Co/Ni/Mn-based cathode. The capacity of the battery may be improved by increasing the amount of the electrode active material that is loaded, but the thickness of the electrode is increased and thus the energy density and the power output characteristics may deteriorate.

Korean Patent Application Publication No. 10-2007-0118313 discloses an electrolyte solution for a lithium ion battery, in which lithium iodide, phosphorus pentachloride and hydrogen fluoride are reacted in a non-aqueous organic solvent to prepare an electrolyte solution including lithium hexafluorophosphate as an electrolyte. In the above patent, however, the use of lithium iodide, which is a material used to prepare lithium hexafluorophosphate, is limited to the reaction with phosphorus pentachloride and hydrogen fluoride. Although the above patent is advantageous in terms of the method of preparing the electrolyte solution, it is ultimately problematic because additional improvements in energy density and power output characteristics of the battery cannot be expected without changing the cathode active material.

Therefore, in order to apply LiFePO₄, serving as a cathode replacing a rare-earth element, to a high-density/high-power lithium secondary battery, it is desired to develop a technique for increasing energy density while maintaining price competitiveness.

### SUMMARY

The present disclosure has been made to address the limitations encountered in the related art. The present disclosure provides an electrolyte solution for a lithium-iron-phosphate-based lithium secondary battery, which replaces the existing rare-earth materials with a lithium salt and a salt additive, thereby providing a price competitive battery.

The present disclosure provides a lithium-iron-phosphate-based lithium secondary battery, which is improved in energy density and capacity without increasing the thickness of the battery.

The present disclosure is not limited to the foregoing, and will be clearly understood through the following description and be realized by the means described in the claims and combinations thereof.

The present disclosure provides an electrolyte solution for a lithium-iron-phosphate-based lithium secondary battery, comprising a salt additive, which is at least one of lithium iodide (LiI), lithium bromide (LiBr), lithium polysulfide, 2,2,6,6-tetramethylpiperidinyl-1-oxyl (TEMPO) or combinations thereof, a lithium salt, and an organic solvent.

The salt additive may be contained at a concentration of 0.1 to 5.4 M.

The lithium salt may be at least one of LiTFSI, LiFSI, LiPF₆, LiBF₄, LiClO₄ or combinations thereof.

The lithium salt may be contained at a concentration of 0.5 to 1.5 M.

The organic solvent may be at least one of dimethyl ether (DEM), 1,3-dioxolane (DOL), 3-methoxypropionitrile (MPN), methyl benzyl nitrate (MBN), tetrahydrofuran (THF), ε-caprolactone (ECL), γ-butyrolactone (GBL), benzenepropanenitrile (BPN), γ-valerolactone (GVL), methoxyacetonitrile (MAN) or combinations thereof.

In addition, the present disclosure provides a lithium-iron-phosphate-based lithium secondary battery, comprising an anode including lithium, a cathode including a cathode active material and a carbon material, a separator membrane disposed between the anode and the cathode, and the above electrolyte solution injected between the anode and the cathode.

The cathode active material may be lithium iron phosphate (LiFePO₄) or lithium iron phosphate (LiFePO₄) surface-coated with carbon.

The carbon material of the cathode may have a specific surface area of 100 m²/g or more.

The cathode may further include a salt additive.

The salt additive may be at least one of lithium iodide (LiI), lithium bromide (LiBr), lithium polysulfide, 2,2,6,6-tetramethylpiperidinyl-1-oxyl (TEMPO) or combinations thereof.

According to the present disclosure, a lithium-iron-phosphate-based lithium secondary battery includes an electrolyte solution including a lithium salt and a salt additive, replacing the existing rare-earth materials to thereby provide the price competitiveness of a battery.

Also, according to the present disclosure, a lithium-iron-phosphate-based lithium secondary battery can be improved in energy density and capacity even without increasing the thickness of a battery and can be inhibited from deteriorating the power output characteristics thereof.

The effects of the present disclosure are not limited to the foregoing, and should be understood to include all effects that can be reasonably anticipated from the following description.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a graph showing changes in capacity and voltage depending on the number of cycles in a lithium-iron-phosphate-based lithium secondary battery manufactured in Example A of the present disclosure;

FIG. 2 is a graph showing the capacity depending on the number of cycles in the lithium-iron-phosphate-based lithium secondary battery manufactured in Example A of the present disclosure; and

FIG. 3 is a graph showing the battery capacity depending on changes in current density of the lithium-iron-phosphate-based lithium secondary batteries manufactured in Example A of the present disclosure and the Comparative Example.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

The above and other objectives, features and advantages of the present disclosure will be more clearly understood from the following variations taken in conjunction with the accompanying drawings. The present disclosure, however, is not limited to the variations disclosed herein and may be modified into different forms. These variations are provided to thoroughly explain the disclosure and to sufficiently transfer the spirit of the present disclosure to those skilled in the art.

Throughout the drawings, the same reference numerals will refer to the same or like elements. For the sake of clarity of the present disclosure, the dimensions of structures are depicted as being larger than the actual sizes thereof. It will be understood that, although terms such as “first” and “second” may be used herein to describe various elements, these elements are not to be limited by these terms. These terms are only used to distinguish one element from another element. For instance, a “first” element discussed below could be themed a “second” element without departing from the scope of the present disclosure. Similarly, the “second” element could also be termed a “first” element. As used herein, the singular forms are intended to include the plural forms as well, unless the context clearly indicates otherwise.

It will be further understood that the terms “comprise”, “include”, “have”, etc., when used in this specification, specify the presence of stated features, integers, steps, operations, elements, components, or combinations thereof, but do not preclude the presence or addition of one or more other features, integers, steps, operations, elements, components, or combinations thereof. Also, it will be understood that when an element such as a layer, film, area, or sheet is referred to as being “on” another element, it can be directly on the other element, or intervening elements may be present therebetween. Similarly, when an element such as a layer, film, area, or sheet is referred to as being “under” another element, it can be directly under the other element, or intervening elements may be present therebetween.

Unless otherwise specified, all numbers, values, and/or representations that express the amounts of components, reaction conditions, polymer compositions, and mixtures used herein are to be taken as approximations including various uncertainties affecting the measurements that essentially occur in obtaining these values, among others, and thus should be understood to be modified by the term “about” in all cases. Furthermore, when a numerical range is disclosed in this specification, the range is continuous, and includes all values from the minimum value of said range to the maximum value thereof, unless otherwise indicated. Moreover, when such a range pertains to integer values, all integers including the minimum value to the maximum value are included, unless otherwise indicated.

Hereinafter, a detailed description will be given of one form of the present disclosure.

As described above, a conventional lithium secondary battery is limited to the extent in which the cost of manufacturing a battery may be reduced due to the use of rare-earth materials such as Co, Ni and Mn. An alternative cathode thereto is disadvantageous because of the low capacity thereof, making it impossible to realize high energy density.

Hence, according to the present disclosure, a lithium-iron-phosphate-based lithium secondary battery includes an electrolyte solution including a lithium salt and a salt additive, which replaces the existing rare-earth materials and thereby provides the price competitiveness of the battery. Furthermore, even without increasing the thickness of the battery, the capacity and the energy density thereof may be improved, and the power output characteristics thereof may be inhibited from decreasing.

The electrolyte solution for a lithium-iron-phosphate-based lithium secondary battery according to the present disclosure includes a salt additive being at least one of lithium iodide (LiI), lithium bromide (LiBr), lithium polysulfide, 2,2,6,6-tetramethylpiperidinyl-1-oxyl (TEMPO) or combinations thereof, a lithium salt, and an organic solvent.

In addition to lithium iron phosphate, the salt additive functions as a second active material, through electrochemical oxidation and reduction of anions resulting from dissociation in the electrolyte solution, thereby increasing both the capacity and the energy density of the battery. This material is much less expensive compared to the existing rare-earth materials, thus ensuring the price competitiveness of the battery. Also, the anions thus produced are present in an easily movable ionic form in the electrolyte solution and may thus exhibit higher power output characteristics, unlike solid active materials. The concentration of the salt additive may be determined by saturation solubility in the organic solvent. Specifically, the salt additive may be contained at a concentration of 0.1 to 5.4 M. If the concentration of the salt additive is less than 0.1 M, a substantial improvement in the battery capacity cannot be expected due to the limitation of the amount of the active material. On the other hand, if the concentration of the salt additive exceeds 5.4 M, the power output characteristics may be deteriorated due to an increase in the viscosity of the electrolyte solution. Preferably, the salt additive is contained at a concentration of 0.6 to 2.8 M.

NOM The lithium salt may be at least one of LiTFSI, LiFSI, LiPF₆, LiBF₄, LiClO₄ or combinations thereof. The lithium salt may be contained at a concentration of 0.5 to 1.5 M.

The organic solvent may be present in a stable manner together with the lithium salt when the salt additive is dissolved therein. Specifically, the organic solvent may be at least one of dimethyl ether (DEM), 1,3-dioxolane (DOL), 3-methoxypropionitrile (MPN), methyl benzyl nitrate (MBN), tetrahydrofuran (THF), ε-caprolactone (ECL), γ-butyrolactone (GBL), benzenepropanenitrile (BPN), γ-valerolactone (GVL), methoxyacetonitrile (MAN) or combinations thereof. Preferably the organic solvent is at least one of dimethyl ether (DEM), 1,3-dioxolane (DOL), methyl benzyl nitrate (MBN) or combinations thereof. Table 1 below shows the saturation concentration of the salt additive in each organic solvent.

TABLE 1

| Kind | DOL | DME | MPN | MBN | THF | ECL | GBL | BPN | GVL | MAN |
|---|---|---|---|---|---|---|---|---|---|---|
| Saturation | 5.5 | 0.6 | 5.4 | 2.8 | 3.2 | 2.4 | 4.2 | 3.6 | 4.0 | 5.0 |
| concentration | | | | | | | | | | |
| of salt | | | | | | | | | | |
| additive (M) | | | | | | | | | | |

In addition, the present disclosure pertains to a lithium-iron-phosphate-based lithium secondary battery, comprising an anode including lithium, a cathode including a lithium iron phosphate active material coated with a carbon material, a separator membrane disposed between the anode and the cathode, and the electrolyte solution injected between the anode and the cathode.

The anode may be at least one of lithium (Li), lithium-intercalated graphite (LiC₆) or combinations thereof. Preferably, the anode is lithium (Li) metal.

As the cathode active material, a compound containing no rare-earth element may be used in order to replace an existing cathode including rare-earth elements such as Co, Ni, and Mn. Specifically, the cathode active material may be lithium iron phosphate (LiFePO₄) or lithium iron phosphate (LiFePO₄) surface-coated with carbon. In particular, the lithium iron phosphate surface-coated with carbon is improved in electrical conductivity to promote the oxidation and reduction of the salt additive. Here, the coating thickness of carbon may range from 10 nm to 10 μm to attain sufficient electrical conductivity.

The cathode material surface-coated with carbon may have a specific surface area of 100 m²/g or more. If the specific surface area of the cathode material surface-coated with carbon is less than 100 m²/g, sufficient oxidation and reduction of the salt additive may become difficult. Preferably, the cathode material surface-coated with carbon has a specific surface area of 300 to 500 m²/g.

The cathode may further include a salt additive. In the cathode, the salt additive, which is dissociated in the electrolyte and is thus present in ionic form, may also function as an active material in addition to the solid lithium iron phosphate, thereby further increasing the battery capacity.

The salt additive may be at least one of lithium iodide (LiI), lithium bromide (LiBr), lithium polysulfide, 2,2,6,6-tetramethylpiperidinyl-1-oxyl (TEMPO) or combinations thereof.

A better understanding of the present disclosure will be given through the following examples, which are not to be construed as limiting the present disclosure.

### EXAMPLE A

A lithium-iron-phosphate-based lithium secondary battery, in which an anode, an electrolyte-solution-incorporated separator membrane and a cathode were sequentially stacked, was manufactured through a typical process. The anode was lithium metal, and the cathode was a mixture comprising LiFePO₄ surface-coated with carbon, PVdF (polyvinylidene fluoride) and acetylene black mixed at a weight ratio of 80:10:10. The separator membrane was PE (polyethylene), the electrolyte solution was 0.5 M LiTFSI as a lithium salt, and a salt additive was 0.5 M LiI. Furthermore, an organic solvent was a mixture of DOI and DME mixed at a volume ratio of 1:1. Based on the total amount of the electrolyte solution, 5 wt% of LiNO₃ was further added.

### Comparative Example

A lithium-iron-phosphate-based lithium secondary battery was manufactured using the same composition in the same manner as in Example A above, with the exception of using 1M LITFSI in lieu of 0.5 M LiI to equally set the total salt concentration in the electrolyte solution composition.

### Test Example 1

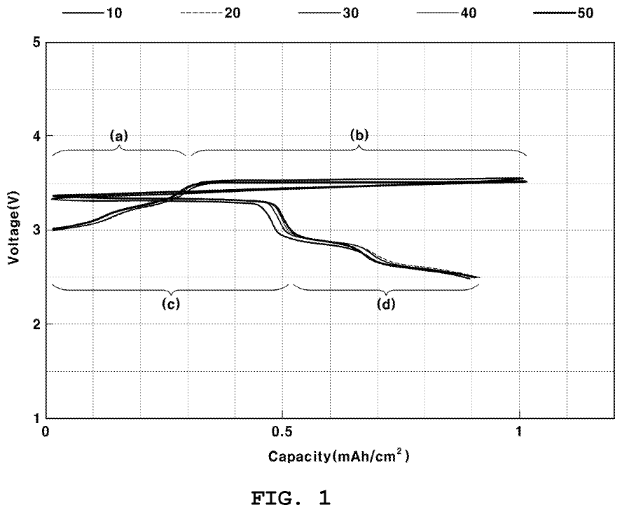

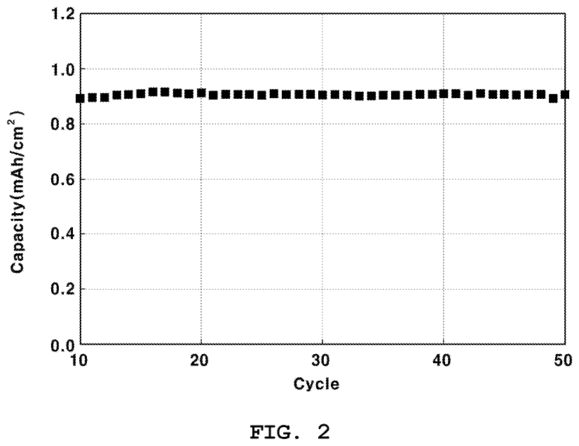

The lithium-iron-phosphate-based lithium secondary battery manufactured in Example A was charged and discharged at a current density of 1 mA/cm² and a preset capacity of 1 mAh/cm². The results are shown in FIGS. 1 and 2.

FIG. 1 is a graph showing changes in the capacity and voltage depending on the number of cycles of the lithium-iron-phosphate-based lithium secondary battery manufactured in Example A. FIG. 2 is a graph showing the capacity depending on the number of cycles of the lithium-iron-phosphate-based lithium secondary battery manufactured in Example A.

With reference to FIGS. 1 and 2, charging occurred in the regions of (a) and (b) and discharging occurred in the regions of (c) and (d). Upon charging and discharging of the lithium secondary battery, the reactions of Schemes 1 and 2 below took place at the cathode and the anode.

[Scheme 1: Charge]

Cathode: (liquid) 3I⁻→I₃⁻2e⁻(a) (solid) LiFePO₄→Li⁺e⁻+FePO₄ (b)

Anode: Li⁺e⁻Li POW [Scheme 2: Discharge]

Cathode: (liquid) I₃⁻+2e⁻→3I (c) (solid) FePO₄+Li⁺e⁻LiFePO₄ (d)

Anode: Li→Li⁺e⁻

During charging, oxidation of iodine ions on the surface of the cathode at a voltage of about 3.0 to 3.5 V, and subsequently, oxidation in which lithium ions were deintercalated from lithium iron phosphate at a voltage of 3.5 V occurred. Also, during discharging, reduction of lithium iron phosphate at the cathode at a voltage of 3.5 V, and subsequently, reduction of trivalent iodine ions up to 3.0 V occurred, as can be confirmed through a potential capacity profile. Even when the number of cycles was about 50 or more, it was confirmed that the battery capacity was maintained constant resulting in stable performance.

### Test Example 2

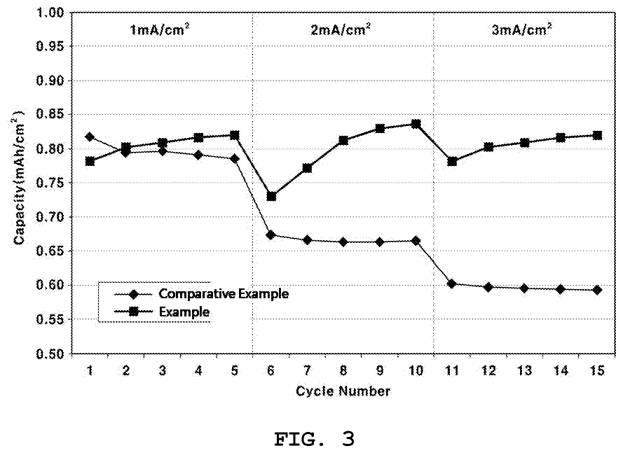

The battery capacity depending on changes in the current density of the secondary batteries manufactured in Example A and the Comparative Example was evaluated. The results are shown in FIG. 3.

FIG. 3 is a graph showing the battery capacity depending on changes in the current density of the lithium-iron-phosphate-based lithium secondary batteries manufactured in Example A and the Comparative Example. With reference to FIG. 3, based on the results of comparing the rate characteristics (power output performance) of the batteries by increasing the applied current density step by step, it was confirmed that higher capacity was maintained at a high current of about 2 mA /cm² or more in Example A compared to the Comparative Example using LiTFSI alone. This is deemed to be because iodine ions may easily move in the electrolyte solution to thus facilitate the charge transfer reaction. Thus, the present disclosure can be more appropriately applied to an environment requiring a battery to operate under high output conditions.

Although specific variations of the present disclosure have been described with reference to the accompanying drawings, those skilled in the art will appreciate that the present disclosure may be exemplified in other specific forms without changing the technical spirit or desired features thereof. Thus, the variations described above should be understood to be non-limiting and illustrative in every way.

What is claimed is:

1. An electrolyte solution for a lithium secondary battery, comprising:
a salt additive;
a lithium salt; and
an organic solvent,
wherein the salt additive is at least one of lithium iodide (LiI), lithium bromide (LiBr), lithium polysulfide, 2,2,6,6-tetramethylpiperidinyl-1-oxyl (TEMPO) or combinations thereof.

2. The electrolyte solution of claim 1, wherein the salt additive is contained at a concentration of 0.1 to 5.4 M.

3. The electrolyte solution of claim 1, wherein the lithium salt is at least one of LiTFSI, LiFSI, LiPF₆, LiBF₄, LiClO₄ or combinations thereof.

4. The electrolyte solution of claim 1, wherein the lithium salt is contained at a concentration of 0.5 to 1.5 M.

5. The electrolyte solution of claim 1, wherein the organic solvent is at least one of dimethyl ether (DEM), 1,3-dioxolane (DOL), 3-methoxypropionitrile (MPN), methyl benzyl nitrate (MBN), tetrahydrofuran (THF), ε-caprolactone (ECL), γ-butyrolactone (GBL), benzenepropanenitrile (BPN), γ-valerolactone (GVL), methoxyacetonitrile (MAN) or combinations thereof.

6. A lithium secondary battery, comprising:
an anode including lithium;
a cathode including a cathode active material and a carbon material;
a separator membrane disposed between the anode and the cathode; and
the electrolyte solution of claim 1 injected between the anode and the cathode.

7. The lithium secondary battery of claim 6, wherein the cathode active material includes lithium iron phosphate (LiFePO₄) or lithium iron phosphate (LiFePO₄) surface-coated with carbon.

8. The lithium secondary battery of claim 6, wherein the carbon material of the cathode has a specific surface area of 100 m²/g or more.

9. The lithium secondary battery of claim 6, wherein the cathode further includes a salt additive.

10. The lithium secondary battery of claim 9, wherein the salt additive is at least one of lithium iodide (LiI), lithium bromide (LiBr), lithium polysulfide, 2,2,6,6-tetramethylpiperidinyl-1-oxyl (TEMPO) or combinations thereof.
